(19) United States
(12) Patent Application Publication
(10) Pub. No.: US 2015/0232751 A1
(43) Pub. Date: Aug. 20, 2015

(54) FLUORIDE FLUORESCENT COMPOSITION AND WAVELENGTH-CONVERTING DEVICE OF PROJECTOR USING SAME

(71) Applicant: DELTA ELECTRONICS, INC., Taoyuan Hsien (TW)

(72) Inventors: Chun-Che Lin, Taoyuan Hsien (TW); Ru-Shi Liu, Taoyuan Hsien (TW); Keh-Su Chang, Taoyuan Hsien (TW); Yen-I Chou, Taoyuan Hsien (TW); Chi Chen, Taoyuan Hsien (TW)

(21) Appl. No.: 14/489,912

(22) Filed: Sep. 18, 2014

Related U.S. Application Data
(60) Provisional application No. 61/941,613, filed on Feb. 19, 2014.

(30) Foreign Application Priority Data
Jun. 24, 2014 (TW) 103121654

(51) Int. Cl. C09K 11/67; G02B 26/00; G03B 21/20; C09K 11/61

(52) U.S. Cl. CPC C09K 11/675; C09K 11/617; G02B 26/008; G03B 21/204

(57) ABSTRACT

A fluoride fluorescent composition contains a tetravalent manganese ion and 2.7 to 7 fluorine atoms, among which the tetravalent manganese ion is doped so as to be a luminescent center. By the advantage of thermal stability of the fluoride fluorescent composition, the luminance, the purity and the quality of projection of the projector are enhanced.

### CROSS-REFERENCE TO RELATED APPLICATION

This application claims the benefit of U.S. Provisional Application No. 61/941,613 filed on Feb. 19, 2014, and entitled “A PHOSPHOR USING FOR RED LIGHT SOURCE OF LASER PROJECTOR”, the entirety of which is hereby incorporated by reference.

### FIELD OF THE INVENTION

The present invention relates to a fluoride fluorescent composition, and more particularly to a fluoride fluorescent composition and a wavelength-converting device of a projector using the same.

### BACKGROUND OF THE INVENTION

In recent years, a blue light laser source and a wavelength-converting device (e.g. a phosphor wheel) are commonly used as illumination source of a high-end projector for exceeding the energy efficiency limitation of conventional lamps. The blue light, which is one of the three primary color lights, is emitted by the blue light laser source. The red light and the green light are outputted by the red and green phosphor agents. Meanwhile, the blue light, the red light and the green light are adjusted to meet the requirement of the ITU-R Recommendation BT. 709 (i.e. Rec. 709, hereinafter “Rec. 709”), such that the standard gamut of a high definition television (HDTV) is matched, and the three primary color lights are integrated as a D65 white light for displaying or projecting.

However, in a high-lumen projector (output>2000 lm), the transforming efficiency of red phosphor agent is significantly decreased under the thermal impact caused by the high energy density laser. Please refer to FIG. 1. FIG. 1 schematically illustrates the comparison of the heat stability of the nitride red phosphor agent of prior art and the fluoride fluorescent composition of the present invention. The thermal decay of the nitride red phosphor agent CaAlSiN₃:Eu_{0.005} of prior art is occurred when the driving power of the laser is 40 watts. Moreover, when the driving power of the laser is reached to 80 watts, the light-emitting efficiency of the red phosphor agent is approaching saturation. Under this saturation circumstance, the intensity of the green light has to be reduced about 10-30% for adjusting the integrated white light to meet the ratio of the D65 white light, such that the intensity of the integrated white light is reduced and the luminance efficiency of the laser projector is significantly limited.

Please refer to FIG. 2. FIG. 2 schematically illustrates the comparison of the absorption spectrums and the emission spectrums of the nitride red phosphor agent of prior art and the fluoride fluorescent composition of the present invention. As shown in FIG. 2, the emission spectrum of the nitride red phosphor agent CaAlSiN₃:Eu_{0.005} of prior art is a wide spectrum that the emission wavelength is from 520 nanometers to 800 nanometers. That is, the color filters are needed to capture the red light having a wavelength longer than 590-600 nanometers for meeting the requirement of Rec. 709. As a result, the transforming efficiency of the nitride red phosphor agent cannot be contributed to improve the intensity of the red light met the practical demands. Meanwhile, since the excitation spectrum of the nitride red phosphor agent is distributed over the absorption spectrum under 550 nanometers, the green light spectrum is absorbed when a yellow phosphor agent or a green phosphor agent is added for the color adjustment, such that the total light-emitting efficiency is decreased.

Therefore, there is a need of providing an improved fluoride fluorescent composition and an improved wavelength-converting device of a projector using the same in order to overcome the above drawbacks.

### SUMMARY OF THE INVENTION

The present invention provides a fluoride fluorescent composition and a wavelength-converting device of a projector using the same in order to overcome the above-mentioned drawbacks encountered by the prior arts.

The present invention provides a fluoride fluorescent composition and a wavelength-converting device of a projector using the same. By the advantage of thermal stability of the fluoride fluorescent composition, the luminance, the purity and the quality of projection of the projector are enhanced.

The present invention provides a fluoride fluorescent composition and a wavelength-converting device of a projector using the same. Since the fluoride fluorescent composition can be synthesized under the room temperature, the manufacturing process is simpler and the cost is lower, not only the mass production of the fluoride fluorescent composition is implemented, but also the fabricating cost of the projector is effectively reduced.

In accordance with an aspect of the present invention, there is provided a fluoride fluorescent composition adapted to a wavelength-converting device of a projector. The fluoride fluorescent composition contains a tetravalent manganese ion and 2.7 to 7 fluorine atoms. The tetravalent manganese ion is doped so as to be a luminescent center.

In accordance with another aspect of the present invention, there is provided a wavelength-converting device of a projector configured to transform a first waveband light emitted by a solid-state light-emitting element. The wavelength-converting device includes a substrate and a fluoride fluorescent composition. The fluoride fluorescent composition is coated on the substrate for transforming the first waveband light into a second waveband light. The fluoride fluorescent composition contains a tetravalent manganese ion and 2.7 to 7 fluorine atoms. The tetravalent manganese ion is doped so as to be a luminescent center.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the comparison of the heat stability of the nitride red phosphor agent of prior art and the fluoride fluorescent composition of the present invention;

FIG. 2 schematically illustrates the comparison of the absorption spectrums and the emission spectrums of the nitride red phosphor agent of prior art and the fluoride fluorescent composition of the present invention;

FIG. 3 schematically illustrates the XRD diagram of the fluoride fluorescent composition according to an embodiment of the present invention;

FIG. 4 schematically illustrates the intensity-wavelength diagram of the fluoride fluorescent composition according to an embodiment of the present invention and the phosphor agent of prior art;

FIG. 5 schematically illustrates intensity-wavelength diagram of the D65 white light generated by the fluoride fluorescent composition according to an embodiment of the present invention combined with YAG yellow phosphor agent;

FIG. 6A schematically illustrates the transformation between the first waveband light and the second waveband light implemented by the wavelength-converting device according to an embodiment of the present invention;

FIG. 6B schematically illustrates the structure of the wavelength-converting device according to an embodiment of the present invention; and

FIG. 7 schematically illustrates the transformation between the first waveband light and the second waveband light implemented by the wavelength-converting device according to another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

A fluoride fluorescent composition is provided according to an embodiment of the present invention. The fluoride fluorescent composition is adapted to a wavelength-converting device of a projector, including but not limited to a phosphor wheel of a laser projector. The simplest ratio of the fluoride fluorescent composition at least contains a tetravalent manganese ion, which is written by Mn4+, and 2.7 to 7 fluorine atoms, which is written by F. The tetravalent manganese ion is doped into the fluoride fluorescent composition so as to be a luminescent center.

In some embodiments, the fluoride fluorescent composition of the present invention is substantially expressed by a general formula A₂MF₆:Mn⁴⁺. A is at least one of Li, Na, K, Rb, Cs and NH₄, and M is at least one of Ge, Si, Sn, Ti and Zr. In the preferred embodiment, the fluoride fluorescent composition is substantially expressed by a general formula K₂Si₁₋ₓF₆:Mnₓ. The x is less than or equal to 1, and larger than or equal to 0.001.

In some embodiments, the fluoride fluorescent composition of the present invention is substantially expressed by a general formula EMF₆:Mn⁴⁺. E is at least one of Mg, Ca, Sr, Ba and Zn, and M is at least one of Ge, Si, Sn, Ti and Zr.

In some embodiments, the fluoride fluorescent composition of the present invention is substantially expressed by a general formula A₃ZrF₇:Mn⁴⁺. The A is at least one of Li, Na, K, Rb, Cs and NH₄.

In some embodiments, the fluoride fluorescent composition of the present invention is expressed by a formula Ba_{0.65}Zr_{0.35}F_{2.7}:Mn⁴⁺.

The preferred embodiments are illustrated as follows. It should be noted that the following description takes the fluoride fluorescent composition K₂Si₁₋ₓF₆:Mnₓ (0.001≦x≦1) for example. However, the fluoride fluorescent composition of the present invention is not limited therefor.

The preparation method of K₂Si₁₋ₓF₆:Mnₓ could be operated under normal temperature (i.e. room temperature) and pressure by a two-step reaction. At the first step, the compound of K₂MnF₆ is synthesized. Next, the compound of K₂MnF₆ synthesized at the first step is recrystallized with the compound of K₂SiF₆, and the product of K₂Si₁₋ₓF₆:Mnₓ is synthesized at the second step.

Furthermore, the reaction of the first step is written by:

2KMnO₄+2KHF₂+8HF+3H₂O₂→2K₂MnF₆+8H₂O+3O₂

At the first step, the compounds of KMnO₄ and KHF₂ are dissolved in hydrofluoric acid (HF). The solution is placed in water bath for 30 minutes at 0° C., and then hydrogen peroxide (H₂O₂) is dropwisely added into the solution, such that air bubbles are produced. After the bubbles disappear, more hydrogen peroxide is dropwisely added into the solution until the solution is completely converted from a dark purple solution into a yellow solution. After quickly filtering the yellow solution, yellow precipitates, which are K₂MnF₆, are obtained.

At the second step, the compounds of K₂SiF₆ and K₂MnF₆ are dissolved in the hydrofluoric acid. Acetone is dropwisely added into the solution, such that precipitates are produced. After complete reaction, yellow precipitates are obtained by filtering the solution. Next, washing the yellow precipitates with deionized water and acetone, and drying the yellow precipitates at 100° C. for 1 hour, and then the product of K₂Si₁₋ₓF₆:Mnₓ is obtained.

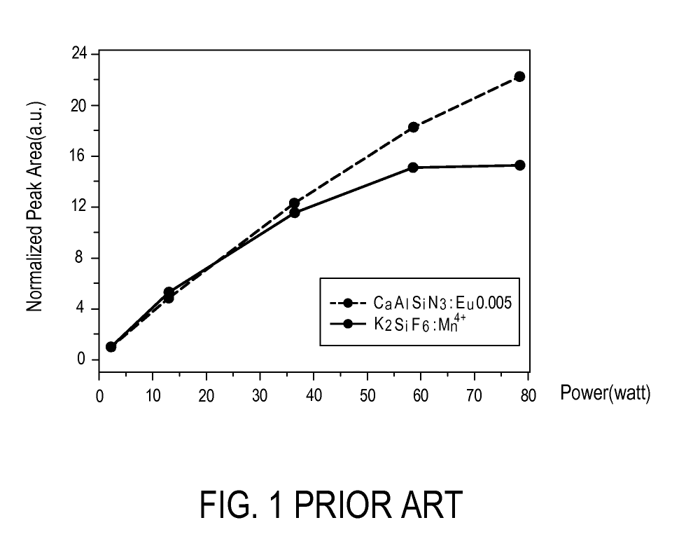

In brief, the fluoride fluorescent composition can be easily synthesized under the room temperature by the above-mentioned two-step reaction, so the cost can be lower and the mass production can be implemented. Additionally, please refer to FIG. 1 again. When the driving power of the laser is reached to 80 watts, the light-emitting luminance of the fluoride fluorescent composition of the present invention is relatively increased about 31% in comparison with CaAlSiN₃:Eu_{0.005} of prior art. That is, by the advantage of thermal stability of the fluoride fluorescent composition of the present invention, the luminance, the purity and the quality of projection of the projector are enhanced. Meanwhile, since the fluoride fluorescent composition can be synthesized under the room temperature, the manufacturing process is simpler and the cost is lower, not only the mass production of the fluoride fluorescent composition is implemented, but also the fabricating cost of the projector is effectively reduced.

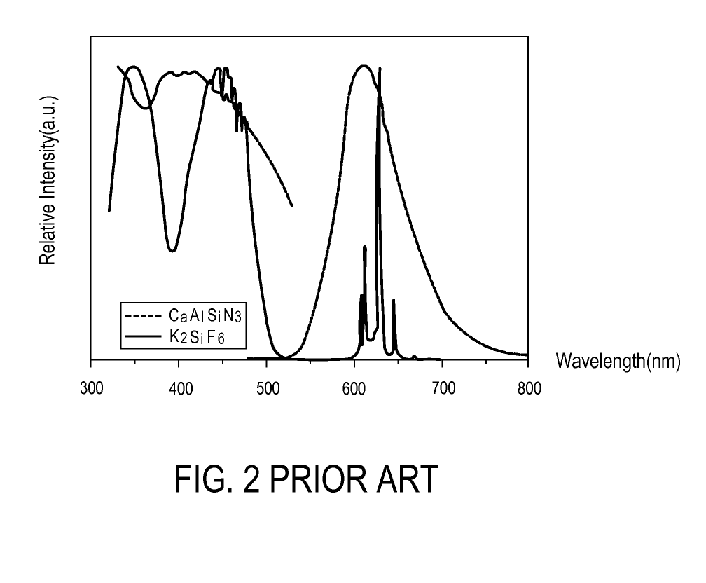

Please refer to FIG. 2 again. The excitation (absorption) spectrum shown in FIG. 2 illustrates that the fluoride fluorescent composition K₂Si_{0.955}F₆:Mn_{0.05} is effectively excited by the blue light laser having wavelength between 430-470 nanometers, and a red light having wavelength between 600-650 nanometers is outputted. Not only the thermal stability is enhanced, but also the reabsorption effect is reduced. Moreover, the outputted red light of the fluoride fluorescent composition K₂Si_{0.95}F₆:Mn_{0.05} is characterized as three narrow spectrums, which are respectively distributed in range about 612 nanometers, 634 nanometers and 648 nanometers. Since the spectrums are located in the effective pupil lumen area (wavelength>600 nanometers) and the color coordinate is located at (0.6930, 0.3069), the compound can be classified as high color-purity compound. As a result, the requirement of the standard red light of Rec. 709, which has a color coordinate located at (0.64, 0.33), is met by the outputted red light of the fluoride fluorescent composition of the present without filtering by any color filter.

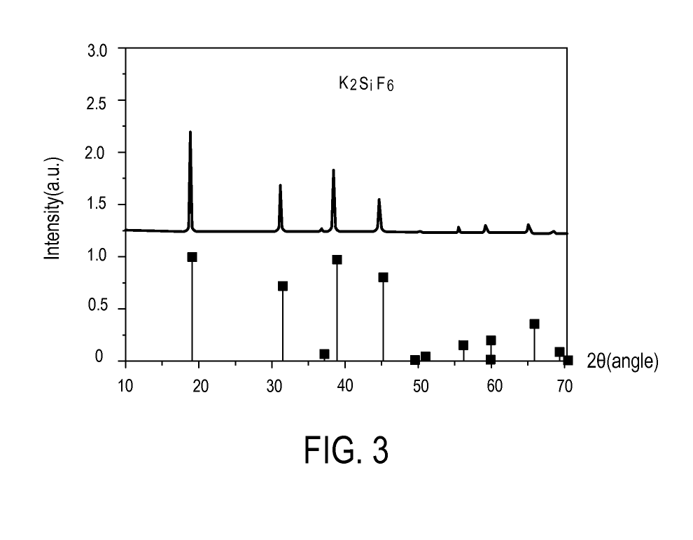

Please refer to FIG. 3. FIG. 3 schematically illustrates the XRD (X-ray powder diffraction) diagram of the fluoride fluorescent composition according to an embodiment of the present invention. As shown in FIG. 3, the crystalline phase purity of the fluoride fluorescent composition K₂Si_{0.95}F₆:Mn_{0.05} synthesized in the above-mentioned embodiments is identified through the XRD. Compared with the standard phase card in FIG. 3, it can be known that the fluoride fluorescent composition of the present invention is a pure phase compound. The pure phase K₂Si_{0.95}F₆:Mn_{0.05} is a positive cubic unit cell structure, among which Si atoms are disposed at six face centers and eight corners.

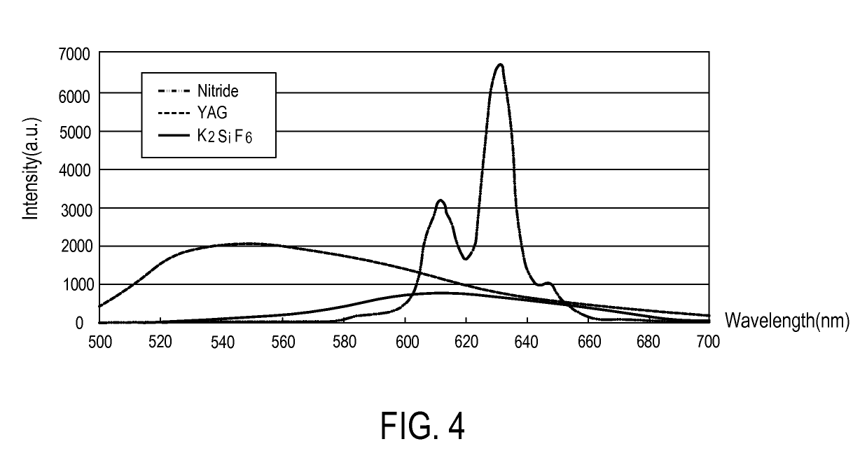

Please refer to FIG. 4. FIG. 4 schematically illustrates the intensity-wavelength diagram of the fluoride fluorescent composition according to an embodiment of the present invention and the phosphor agent of prior art. The fluoride fluorescent composition K₂Si_{0.95}F₆:Mn_{0.05} of the present invention, the conventional nitride red phosphor agent and YAG yellow phosphor agent are respectively utilized as the Rec. 709 red light sources of blue laser projectors, and the light-emitting intensities corresponding to the wavelengths are illustrated in FIG. 4. The light-emitting wavelengths of the fluoride fluorescent composition K₂Si_{0.95}F₆:Mn_{0.05} of the present invention are greater than or equal to 600 nanometers, so that the CIE color coordinates directly meet the requirement of the standard red light of Rec. 709 without corrections or color filters. Therefore, the outputted red light of the fluoride fluorescent composition of the present invention maintains a luminance efficiency about 30.5 lm/W before and after light-filtering. In contrast, as shown in the spectrums of the conventional nitride red phosphor agent and YAG yellow phosphor agent, after filtering the spectrum that is greater than or equal to 600 nanometers by color filters, the energy is lost and the light-emitting efficiency is significantly decreased, which is illustrated in the following Table 1.

Table 1 illustrates the light-emitting efficiencies and the differences before and after light-filtering of the outputted red light of the fluoride fluorescent composition K₂Si_{0.95}F₆:Mn_{0.05} of the present invention, the conventional nitride red phosphor agent and YAG yellow phosphor agent.

TABLE 1

| | Before Light- | | After Light- | |
|---|---|---|---|---|
| | filtering | | filtering | |
| Phosphor Materials | Watt | lm/W | Watt | lm/W |
| Conventional Nitride | 100.0% | 20.5 | 40% | 8.2 |
| Red Phosphor Agent | | | | |
| Fluoride Fluorescent Composition | 148.8% | 30.5 | 130.2% | 30.5 |
| K₂Si_{0.95}F₆:Mn_{0.05} | | | | |
| YAG | 535.1% | 109.7 | 68.8% | 14.1 |
| Yellow Phosphor Agent | | | | |

As shown in Table 1, nearly 60 percent energy loss is occurred with the conventional nitride red phosphor agent. The luminance efficiency of the conventional nitride red phosphor agent is only 8.2 lm/W, which is a quarter of the luminance efficiency of the fluoride fluorescent composition K₂Si_{0.95}F₆:Mn_{0.05} of the present invention. In addition, the filtered red light wavebands, which are provided with the wavelength greater than 590 nanometers, of the conventional nitride red phosphor agent and YAG yellow phosphor agent are also shown in Table 1. In general, the red light is filtered from the yellow light outputted by the YAG yellow phosphor agent for utilization in order to avoid the thermal decay of the conventional nitride red phosphor agent under high watts. Although the luminance of the filtered red light of the YAG yellow phosphor agent is greater than the luminance of the outputted red light of the conventional nitride phosphor agent (14.1 lm/W>8.2 lm/W), the energy loss is reached about 90 percent (535.1%→68.8%). Furthermore, compared with the fluoride fluorescent composition K₂Si_{0.95}F₆:Mn_{0.05} of the present invention with the YAG yellow phosphor agent of prior art, the luminance efficiency of the fluoride fluorescent composition of the present invention is almost twice that of the YAG yellow phosphor agent of prior art. Therefore, the present invention achieves the advantages of enhancing the luminance, purity and image quality of projection.

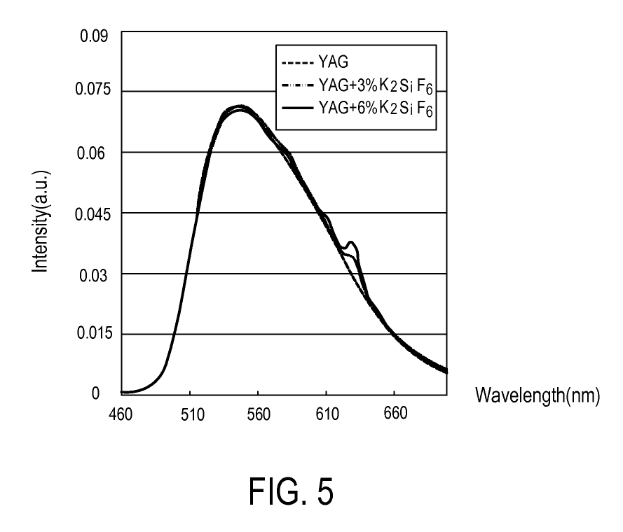

Please refer to FIG. 5. FIG. 5 schematically illustrates intensity-wavelength diagram of the D65 white light generated by the fluoride fluorescent composition according to an embodiment of the present invention combined with YAG yellow phosphor agent. When utilizing a specific yellow phosphor agent for emitting a specific light separated into green light and red light as the illumination system of a laser projector, YAG yellow phosphor agent can be doped in the fluoride fluorescent composition K₂Si_{0.95}F₆:Mn_{0.05} of the present invention. Since only the color light having a wavelength less than 470 nanometers is absorbed by the fluoride fluorescent composition K₂Si_{0.95}F₆:Mn_{0.05} as an excitation source, the green light outputted by YAG yellow phosphor agent is not significantly absorbed. The characterized output wavelength of the fluoride fluorescent composition may further enhance the intensity of the red light (wavelength>600 nm) outputted by YAG yellow phosphor agent. Under this circumstance, the outputted light of the fluoride fluorescent composition of the present invention combined with YAG yellow phosphor agent is separated as the Rec. 709 green light and red light, such that the efficiency of the D65 white light of the laser projector is enhanced.

In the embodiments shown in the following Table 2, the light-emitting efficiency of YAG yellow phosphor agent is decreased from 194.6 lm/W to 188.4 lm/W with the addition of the fluoride fluorescent composition K₂Si_{0.95}F₆:Mn_{0.05} of the present invention, which is caused by that the light-emitting efficiency of the separated Rec. 709 green light is decreased from 136.4 lm/W to 130.6 lm/W. However, the light-emitting efficiency of the separated Rec. 709 red light is increased from 24.9 lm/W to 25.7 lm/W. Since the efficiency of the D65 white light is depended on the light-emitting efficiency of the red light, it should be noted that the light-emitting efficiency of the D65 white light is enhanced at least 5 percent by adding the fluoride fluorescent composition K₂Si_{0.95}F₆:Mn_{0.05} of the present invention into YAG yellow phosphor agent.

Table 2 illustrates the efficiencies and the differences of the D65 white light according to the embodiments of the present invention that YAG yellow phosphor agent is doped in the fluoride fluorescent composition K₂Si_{0.95}F₆:Mn_{0.05} of the present invention.

TABLE 2

| Light-emitting | | | |
|---|---|---|---|
| Efficiency lm/W | YAG | YAG + 3% K2SiF6 | YAG + 6% K2SiF6 |
| Yellow | 194.6 | 193.2 | 188.4 |
| Phosphor Agent | | | |
| Rec. 709 | 24.9 | 25.5 | 25.7 |
| Red Light | | | |
| Rec. 709 | 136.4 | 134.7 | 130.6 |
| Green Light | | | |
| D65 | 115.0 | 119.0 | 121.0 |
| White Light | 100.0% | 103.5% | 105.2% |

From the above embodiments, FIGS. 1-5 and Tables 1-2, it can be found that the embodiments of the fluoride fluorescent composition can be mostly simplified as containing a tetravalent manganese ion and 2.7 to 7 fluorine atoms, and the tetravalent manganese ion is doped so as to be a luminescent center. By the advantage of thermal stability of the fluoride fluorescent composition, the luminance, the purity and the quality of projection of the projector are enhanced. That is, the present invention can be implemented, and the expected advantages can be achieved.

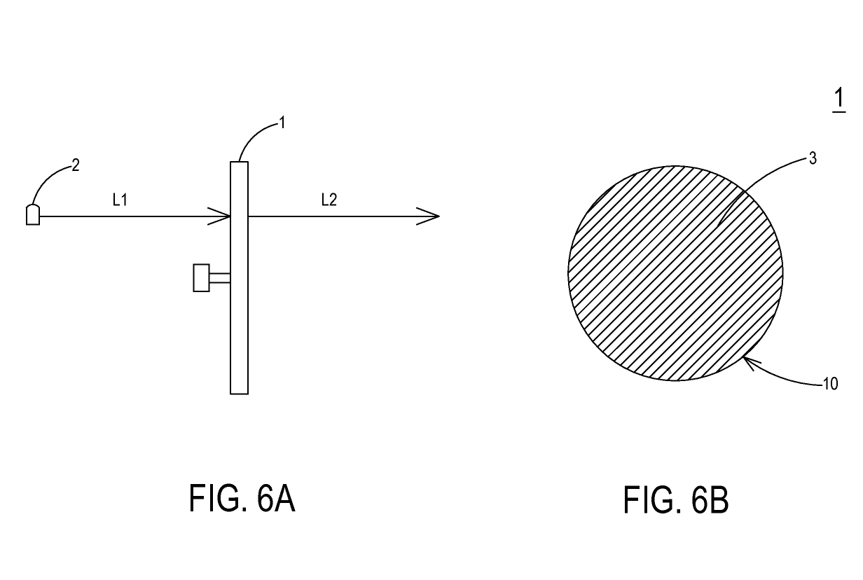

Please refer to FIG. 6A and FIG. 6B. FIG. 6A schematically illustrates the transformation between the first waveband light and the second waveband light implemented by the wavelength-converting device according to an embodiment of the present invention. FIG. 6B schematically illustrates the structure of the wavelength-converting device according to an embodiment of the present invention. As shown in FIG. 6A and FIG. 6B, the wavelength-converting device 1 of the present invention is applied to a projector such as a laser projector, and the wavelength-converting device 1 is not limited to a transmissive wavelength-converting device. The wavelength-converting device 1 is configured for transforming a first waveband light L1 emitted by a solid-state light-emitting element 2, which is preferably a blue laser diode, but not limited herein. The wavelength-converting device 1 includes a substrate 10 and a fluoride fluorescent composition 3 according to any one of the above embodiments. The fluoride fluorescent composition 3 is coated on the substrate 10, and is not limited to coated on the front surface or the rear surface of the substrate 10, for transforming the first waveband light L1 into a second waveband light L2 (e.g. transforming a blue light into a red light).

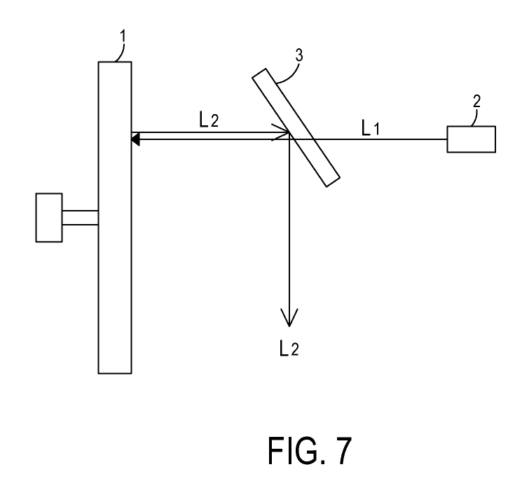

Please refer to FIG. 6B and FIG. 7. FIG. 7 schematically illustrates the transformation between the first waveband light and the second waveband light implemented by the wavelength-converting device according to another embodiment of the present invention. The wavelength-converting device 1 of the present invention can be not only the transmissive wavelength-converting device described in the previous embodiment, but also a reflective wavelength-converting device in this embodiment. The wavelength-converting device 1 is configured for transforming a first waveband light L1 emitted by a solid-state light-emitting element 2, which is preferably a blue laser diode, but not limited herein. The wavelength-converting device 1 includes a substrate 10 and a fluoride fluorescent composition 3. The substrate 10 and the fluoride fluorescent composition 3 are similarly with the previous embodiment, and are not redundantly described herein.

In some embodiments, the wavelength of the first waveband light L1 is less than or equal to 470 nanometers, and greater than or equal to 430 nanometers. That is, the wavelength of the first waveband light Ll is within the range of the blue light waveband. The wavelength of the second waveband light is less than or equal to 650 nanometers, and greater than or equal to 600 nanometers. That is, the wavelength of the second waveband light L2 is within the range of the red light waveband. In the preferred embodiments, the wavelength of the first waveband light L1 is 445 nanometers.

From the above descriptions, the present invention provides a fluoride fluorescent composition and a wavelength-converting device of a projector using the same. By the advantage of thermal stability of the fluoride fluorescent composition, the luminance, the purity and the quality of projection of the projector are enhanced. Meanwhile, since the fluoride fluorescent composition can be synthesized under the room temperature, the manufacturing process is simpler and the cost is lower, not only the mass production of the fluoride fluorescent composition is implemented, but also the fabricating cost of the projector is effectively reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A fluoride fluorescent composition, adapted to a wavelength-converting device of a projector, the fluoride fluorescent composition comprising:
a tetravalent manganese ion; and
2.7 to 7 fluorine atoms,
wherein the tetravalent manganese ion is doped so as to be a luminescent center.

2. The fluoride fluorescent composition according to claim 1, wherein the fluoride fluorescent composition is substantially expressed by a general formula A₂MF₆:Mn⁴⁺, and wherein A is at least one of Li, Na, K, Rb, Cs and NH₄, and M is at least one of Ge, Si, Sn, Ti and Zr.

3. The fluoride fluorescent composition according to claim 2, wherein the fluoride fluorescent composition is substantially expressed by a general formula K₂Si₁₋ₓF₆:Mnₓ, and wherein x is less than or equal to 1, and larger than or equal to 0.001.

4. The fluoride fluorescent composition according to claim 1, wherein the fluoride fluorescent composition is substantially expressed by a general formula EMF₆:Mn⁴⁺, and wherein E is at least one of Mg, Ca, Sr, Ba and Zn, and M is at least one of Ge, Si, Sn, Ti and Zr.

5. The fluoride fluorescent composition according to claim 1, wherein the fluoride fluorescent composition is substantially expressed by a general formula A₃ZrF₇:Mn⁴⁺, and wherein A is at least one of Li, Na, K, Rb, Cs and NH₄.

6. The fluoride fluorescent composition according to claim 1, wherein the fluoride fluorescent composition is expressed by a formula Ba₀₆₅Zr_{0.35}F_{2.7}:Mn⁴⁺.

7. A wavelength-converting device of a projector, configured to transform a first waveband light emitted by a solid-state light-emitting element, the wavelength-converting device comprising:
a substrate; and
the fluoride fluorescent composition according to any one claim of claims 1-5, wherein the fluoride fluorescent composition is coated on the substrate for transforming the first waveband light into a second waveband light.

8. The wavelength-converting device according to claim 7, wherein the wavelength of the first waveband light is less than or equal to 470 nanometers, and greater than or equal to 430 nanometers.

9. The wavelength-converting device according to claim 7, wherein the wavelength of the first waveband light is 445 nanometers.

10. The wavelength-converting device according to claim 7, wherein the wavelength of the second waveband light is less than or equal to 650 nanometers, and greater than or equal to 600 nanometers.
